(19) United States
(12) Patent Application Publication
(10) Pub. No.: US 2014/0214379 A1
(43) Pub. Date: Jul. 31, 2014

(54) System and Method for Reactive Transport Modeling

(71) Applicant: AQUEOUS SOLUTIONS LLC, CHAMPAIGN, IL (US)

(72) Inventors: Craig M. Bethke, Champaign, IL (US); Daniel Saalfeld, Champaign, IL (US)

(73) Assignee: AQUEOUS SOLUTIONS LLC, CHAMPAIGN, IL (US)

(21) Appl. No.: 14/164,189

(22) Filed: Jan. 25, 2014

Related U.S. Application Data
(60) Provisional application No. 61/756,737, filed on Jan. 25, 2013.
(60) Provisional application No. 61/778,030, filed on Mar. 12, 2013.

(51) Int. Cl. G06F 19/00

(52) U.S. Cl. CPC G06F 19/702
USPC 703/2; 703/12

(57) ABSTRACT

The system and method described herein describe using a cross-linkable re-entrant software instances or routine to create software for modeling reactive transport. An arbitrary number of instances of such a routine may be launched and operated independently of each other and each instance of such a routine may be cross linkable. Each instance may access the memory space of other instances. Once one instance of a routine is linked to another instance, the instances may compute the rate at which mass and heat energy move from the first to the second, or vice versa. The system may model of a broad range of problems involving chemical reactions within systems that contain a mobile phase or phases.

### PRIORITY

This application claims priority to U.S. Provisional Application No. 61/756,737, entitled “SYSTEM AND METHOD FOR REACTIVE TRANSPORT MODELING,” filed on Jan. 25, 2013, and claims priority to U.S. Provisional Application No. 61/778,030, entitled “SYSTEM AND METHOD FOR REACTIVE TRANSPORT MODELING,” filed on Mar. 12, 2013, the entire disclosure of both are hereby incorporated by reference.

### FIELD

This application relates to reactive transport modeling. More particularly, the application pertains to the use of software to construct numerical models of reactive transport.

### BACKGROUND

The field of reactive transport modeling is a subset and intersection of the fields of chemistry, chemical engineering, and geochemistry that seeks to describe and predict how chemical reactions are distributed in space and time in the presence of a moving fluid, gas, or plasma, or combination thereof. In a number of circumstances encountered in engineering and the natural science, chemical reactions occur within a substance that is not stationary, but instead in motion relative to its environment. Chemical reactions may include those involving inorganic or organic species, or both; and those reactions may proceed with or without the influence of biologic mediation, or both. As an example, chemical reactions may proceed within a fluid as it moves through the plumbing, tanks, and appliances of an industrial plant or water treatment facility. The ability to design, construct, and operate such installations may require an accurate quantitative description of the progress and interaction of such reactions. As another example, toxic and harmful contaminants, once they have been introduced into the environment, migrate with the flow of water along aquifers, streams and rivers, and lake and ocean currents. The contaminants may react chemically and be transformed in various ways that can render them less toxic, or make them more toxic. Reactions may also decrease or increase the ability of contaminants to move along with the water flow. Reactive transport models may be used to gauge the necessity and efficacy of attempts toward environmental remediation. Models may also be employed to design waste disposal facilities, such as repositories for isolating high-level radioactive waste from the human environment. As a third example, the pipe networks carrying municipal water supplies may be vulnerable to terrorist attack via the introduction of poisonous compounds. In the event of an attack, or to prepare effective plans for responding to such an attack, a municipality might need to predict the fate of a poisonous compound as it migrates through the pipe network and reacts chemically. It may seek to prepare a reliable reactive transport model, perhaps on an urgent basis.

As computing power has increased, there have been more attempts to construct and apply reactive transport models to systems containing an arbitrary number of chemical components. The model may be a combination of transport modeling and multi-component chemical modeling. One feature of the existing and available software programs for reactive transport modeling is that in each case the code for solving the multi-component transport and reaction equations must be laboriously written, tested, and perfected de novo by an individual or group. A related issue is that since evaluating a reactive transport model may in many cases require considerable computation, there is a need to adapt a software program once developed to execute in parallel on computers with multiple processors. This adaptation, which requires care and expert skills, must be implemented, tested, and perfected individually for each reactive transport code. Some attempts have been made to cast a geochemical model as software object. However, the complexity and sophistication of such models is constrained by the functions of these software objects, which are limited to modeling chemical reactions in a system in which the net transport of chemical mass and heat from one object to another is accomplished by a computing processes external to the objects and then communicated to the objects by said external computing process. A user of a model based on such software objects must also undertake the creation of specialized code to handle input and output as required by a particular scripting language. Accordingly, relatively few modeling programs are publically available, and those that are available may lack features for addressing all possible scenarios within a model.

### BRIEF DESCRIPTION OF THE DRAWINGS

The system and method may be better understood with reference to the following drawings and description. Non-limiting and non-exhaustive embodiments are described with reference to the following drawings. The components in the drawings are not necessarily to scale, emphasis instead being placed upon illustrating the principles of the invention. In the drawings, like referenced numerals designate corresponding parts throughout the different views.

FIG. 1 is a flow chart illustrating creation of a reactive transport model using cross linked instances of a software routine according to one embodiment.

FIG. 2 illustrates a conceptual model upon which an instance of a software routine may be constructed according to one embodiment.

FIG. 3 illustrates a configuration of cross-linked instances which may model an industrial process.

FIGS. 4a illustrates a three dimensional body of moving water and FIG. 4b illustrates a configuration of cross-linked instances that models the three dimensional body.

FIGS. 5a illustrates water drainage in a basin and FIG. 5b illustrates a configuration of cross-linked instances in a dendritic configuration that models the water drainage.

FIG. 6 illustrates a configuration of cross-linked instances that models a fluid distribution network.

FIG. 7 is a flow chart of parallel computing of reactive transport.

FIG. 8 illustrates a computer network architecture.

### DETAILED DESCRIPTION

The system and method described herein describe a reactive transport model using cross linked re-entrant instances or subroutines. The system and method address the underlying problem of creating a reactive transport code and adapting it to a parallel computer architectures quickly, simply, and reliably. The software routine may be re-entrant, such that it is a software object whose memory space is encapsulated and whose functionality is self-contained. Accordingly, an arbitrary number of instances of such a routine may be launched and operated independently of each other. Each instance of such a routine may be cross linkable, so each instance may access the memory space of other instances, while the instances have been launched as part the same computing process. Once one instance of a routine is linked to another instance, the instances may compute the rate at which mass and heat energy move from the first to the second, or vice versa.

The system may include a software routine that may 1) compute the transport of mass and heat energy to and from other such routines, and 2) solve equations describing the state of chemical reactions among an arbitrary number of aqueous species, gas species, solid species, plasma species, and surface species. Any, some, or all of the reactions may be in chemical equilibrium, and any that are not in equilibrium may react according to kinetic rate equations. A reactive transport model for an arbitrary configuration may be created by 1) launching an instance of a routine for each subdivision of the system to be modeled; 2) creating links among the instances that represent flow of the mobile phase from one subdivision to a neighboring subdivision; and 3) prescribing the flow rate of the mobile phase across each such link. Each instance internally may 1) compute the transport of chemical components and/or heat energy among the instances; and 2) solve the reaction equations within each instance. This may result in the construction of a reactive transport model for a system of arbitrary configuration.

Other systems, methods, features and advantages will be, or will become, apparent to one with skill in the art upon examination of the following figures and detailed description. It is intended that all such additional systems, methods, features and advantages be included within this description, be within the scope of the invention, and be protected by the following claims. Nothing in this section should be taken as a limitation on those claims. Further aspects and advantages are discussed below.

Subject matter will now be described more fully hereinafter with reference to the accompanying drawings, which form a part hereof, and which show, by way of illustration, specific example embodiments. Subject matter may, however, be embodied in a variety of different forms and, therefore, covered or claimed subject matter is intended to be construed as not being limited to any example embodiments set forth herein; example embodiments are provided merely to be illustrative. Likewise, a reasonably broad scope for claimed or covered subject matter is intended. Among other things, for example, subject matter may be embodied as methods, devices, components, or systems. Accordingly, embodiments may, for example, take the form of hardware, software, firmware or any combination thereof (other than software per se). The following detailed description is, therefore, not intended to be taken in a limiting sense.

Throughout the specification and claims, terms may have nuanced meanings suggested or implied in context beyond an explicitly stated meaning. Likewise, the phrase “in one embodiment” as used herein does not necessarily refer to the same embodiment and the phrase “in another embodiment” as used herein does not necessarily refer to a different embodiment. It is intended, for example, that claimed subject matter include combinations of example embodiments in whole or in part.

In general, terminology may be understood at least in part from usage in context. For example, terms, such as “and”, “or”, or “and/or,” as used herein may include a variety of meanings that may depend at least in part upon the context in which such terms are used. Typically, “or” if used to associate a list, such as A, B or C, is intended to mean A, B, and C, here used in the inclusive sense, as well as A, B or C, here used in the exclusive sense. In addition, the term “one or more” as used herein, depending at least in part upon context, may be used to describe any feature, structure, or characteristic in a singular sense or may be used to describe combinations of features, structures or characteristics in a plural sense. Similarly, terms, such as “a,” “an,” or “the,” again, may be understood to convey a singular usage or to convey a plural usage, depending at least in part upon context. In addition, the term “based on” may be understood as not necessarily intended to convey an exclusive set of factors and may, instead, allow for existence of additional factors not necessarily expressly described, again, depending at least in part on context.

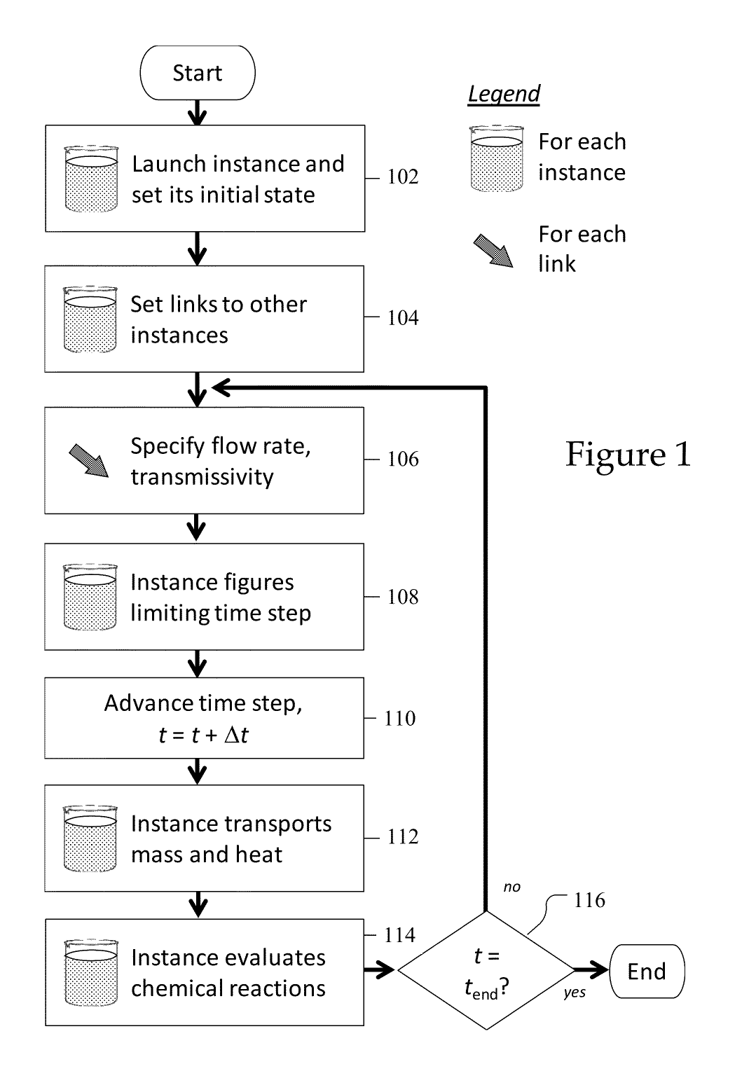

FIG. 1 is a flow chart illustrating creation of a reactive transport model using cross linked instances of a software routine according to one embodiment. In particular, FIG. 1 illustrates an exemplary embodiment for creating a reactive transport model. A software routine may be used to create the reactive transport model, and to prepare for the calculation, a system to be modeled may be subdivided into a series of reactor mediums. The system may be a continuous physical system, such as an aquifer, or a discrete physical system, such as an industrial plant composed of reactor tanks connected by pipes. Such systems may also be referred to as domains. A domain may have physical regions or sub-regions connected by one or more flow relationships permitting the flow of any, some, or all of a mobile phase, a chemical species, and heat between the physical regions or sub-regions. A flow relationship may be, for example, movement of a mobile phase between regions or sub-regions or movement of heat by conduction between regions or sub-regions. Movement of a mobile phase or of heat may be effected by, for example, adjacency between regions or sub-regions in a continuous domain, interconnectivity between regions or sub-regions in a discrete domain by connections such as pipes, or any other forms of interconnectivity permitting hydraulic or thermal connectivity known to persons of ordinary skill in the art.

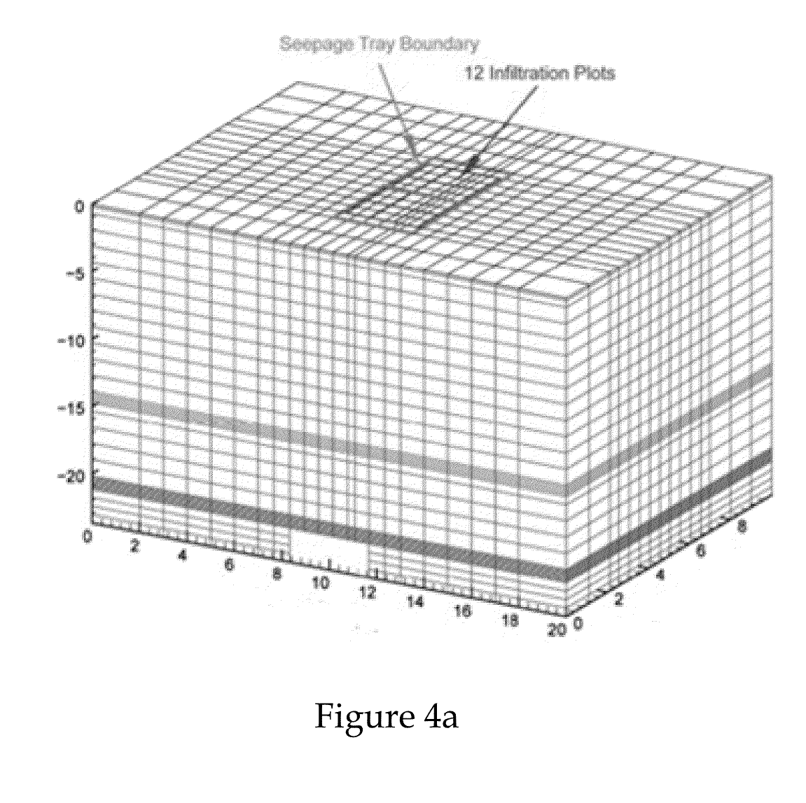

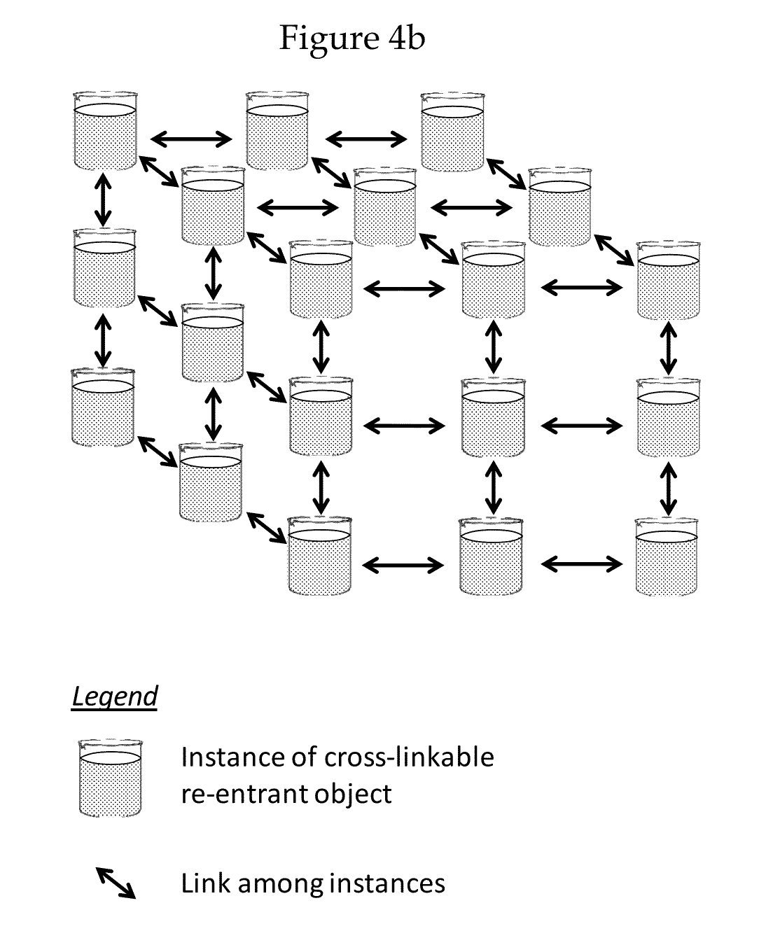

A reactor medium may be a physical region or sub-region of such a domain within which chemical reactions may occur due to any, some, or all of: the influence of influx or efflux of mass to or from the reactor medium, influx or efflux of heat energy to or from the reactor medium, and passage of time. The task of subdividing a domain to be modeled may be performed on the basis of whether the domain is continuous or discrete, flow relationships between physical regions or sub-regions, and/or other criteria. In one embodiment, a user may perform the subdivision of a domain to be modeled into a series of reactor mediums. In an alternative embodiment, a gridding program running on a computer may perform the subdivision of a domain to be modeled into a series of reactor mediums (as in FIGS. 4a-4b described below).

In block 102 of FIG. 1, a program running on a computer may launch an independent instance of a software routine for each reactor medium of the system, and may set an initial state (e.g. a chemical state or thermal state) for each such instance launched. An instance of a software routine may represent a reactor medium within a system, and may have a scope representing the region or sub-region to which the reactor medium corresponds.

A re-entrant software routine may be coded in an object oriented programming language so that the routine itself constitutes a software object. Examples of object oriented programming languages may include but are not limited to C++ and Java. Because a re-entrant software routine constitutes an object, its memory space may be encapsulated as a data field and its functionality carried internally as a collection of member functions. An object with an encapsulated memory space may have the property in computer science of being re-entrant. An object's member functions may allow an object to be operated in such a way that the object may transform its state, as carried in its memory space. These attributes of the object allow individual instances of the routine to function independently.

An instance of a software routine may trace the progress of chemical reactions occurring within its scope. In one embodiment, the program may be a parent process that launches more than one instance of a re-entrant software routine as subprocesses within the parent process. Each instance may be operated as an autonomous entity within the parent process, functioning independently of each other instance. Each instance may have an encapsulated memory space. To track the progress of chemical reactions occurring within its scope, the instance may provide a state with a value, modeling conceptual items occurring within its scope. The value of a state of an instance may be stored within the memory space of the instance. The program may define one or more initial states for each of the instances.

As described, the software routine instances may be cross-linked with one or more neighbors. When two instances of the software object are triggered to link, one of the instances receives a pointer to the neighboring instance's location in memory. In other words, the first instance adds that pointer to its list of neighbors. It then reciprocates by adding a pointer to its own memory location to the neighbor's list of neighbors. At this point the link is reciprocal and each instance has access to the other instance's memory space. If the instances were not re-entrant, it may not be possible to spawn separate instances representing different parts of the domain, since the instances may not be independent. Further, it may hinder the ability to link instances. The linking described herein, and in particular, the way in which instances link to other instances may be referred to as self-linking. Once a linking is triggered, the linking may be performed by an instance.

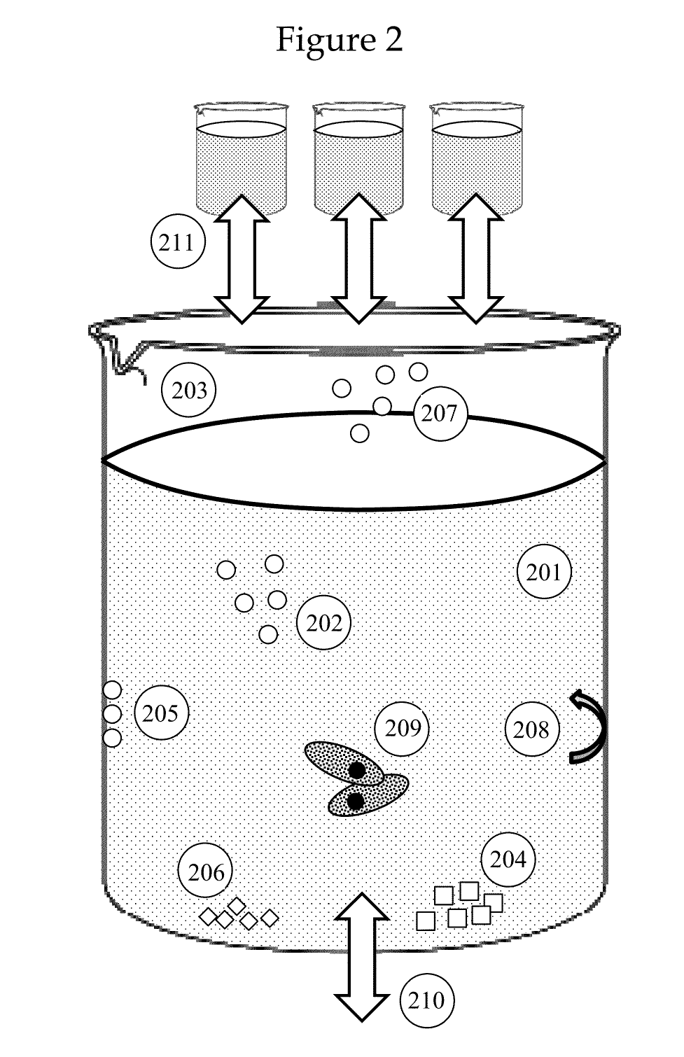

FIG. 2 illustrates a conceptual model upon which an instance of a software routine may be constructed according to one embodiment. In particular, FIG. 2 illustrates conceptual items within the scope of an instance. A mobile phase 201 may be a fluid, gas, plasma, or a combination thereof. A molecular species 202 may be within the mobile phase and may include ions in an aqueous fluid in one example. A coexisting gas mixture 203 may be in equilibrium with the fluid or mobile phase 201. Buffer solids 204 of known solubility may be held in equilibrium with the fluid or mobile phase 201. A species 205 may be sorbed to or complexed with a phase interface (surface). The species 205 may form or decompose according to a kinetic rate equation. Solids 206 may precipitate or dissolve according to a kinetic rate equation. Gaseous species 207 may ex-solve from or dissolve into the fluid or the mobile phase 201 according to a kinetic rate equation. Reactions 208 may proceed due to the presence of a catalyst or enzyme, or as a result of biological activity. Microbial cells 209 may catalyze reactions in the mobile phase 201, reproduce, and die. There may be a source or sink 210 of heat energy. Finally, there may be at least one cross-link 211 to other instances of the cross-linkable routine. The cross-link(s) 211 to other instances of the routine may be for a transfer of mass, chemical species, and/or heat energy.

Referring back to FIG. 1, the program may set one or more links among instances in block 104. Each link may connect at least a first instance and a second instance. A link may be set between instances if the instances represent reactor mediums that are connected by a flow relationship. Instances representing neighboring reactor mediums in a continuous domain (such as portions of an aquifer), or reactor mediums that feed fluid or heat energy to each other in a discrete domain (such as individual reactor tanks connected by pipes in an industrial plant) are cross linked. The flow across a link between instances may be modeled. The model may be of any, some, or all of mobile phases, chemical species, and heat, across the reactor mediums represented by the instances connected by the link. The flow of mobile phases, chemical species, or heat across a link may be unidirectional in either direction or may be bidirectional, and each type of flow may run along with, or counter, to each other type of flow. For the flow of a mobile phase, a chemical species, or heat across a link, an “upstream instance” may be the instance from which the mobile phase, chemical species, or heat flows, and “downstream instance” refers to the other instance.

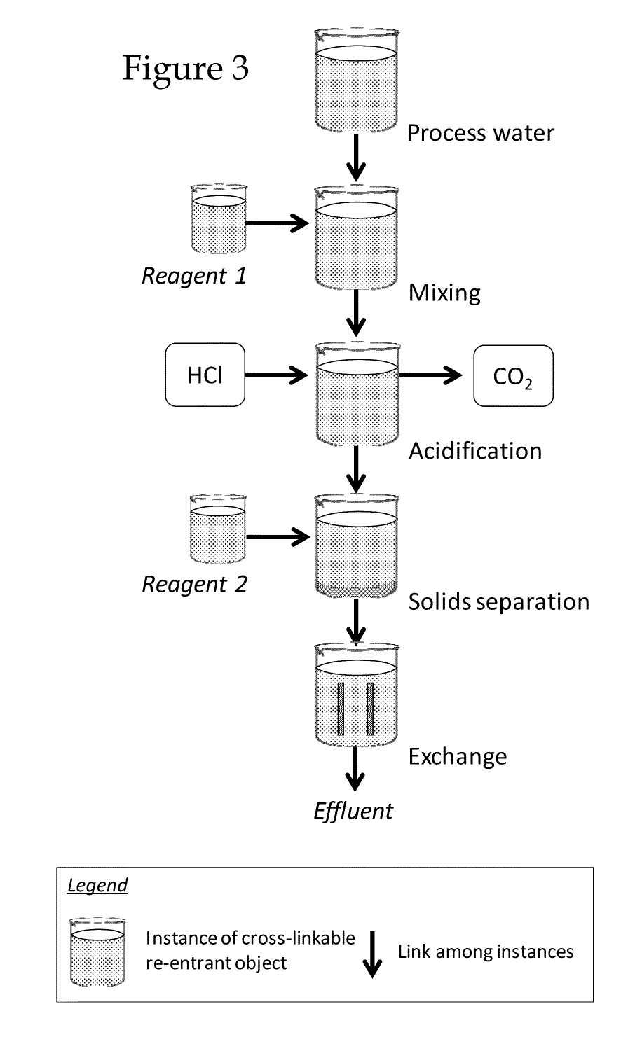

FIGS. 3-6 illustrate exemplary configurations of cross-linked instances forming a cross-linked structure or cross-linked network of instances. Configurations for such structures or networks may be linear, branched, two-dimensional, three-dimensional, or other topologies. The configuration of a plurality of cross-linked instances may represent various models in reactive transport modeling.

FIG. 3 illustrates a configuration of cross-linked instances which may model an industrial process. FIG. 3 shows how instances may be configured to create a reactive transport model of an industrial process or water treatment plant. The industrial process may include fluid mixing, acidification, separation of solids, and ion exchange. Each instance may represent a single reaction tank in the process stream and the links may represent connections among the tanks.

FIGS. 4a illustrates a three dimensional body of moving water and FIG. 4b illustrates a configuration of cross-linked instances that models the three dimensional body. FIG. 4a illustrates a division of a body of water, such as an aquifer through which groundwater flows, or a body of moving water, such as a stream, or a lake or ocean current. FIG. 4b shows how instances may be configured to create a three dimensional reactive transport model of the system shown in FIG. 4b. Each instance may represent a subdivision of the aquifer or water body and the links represent the flow of water.

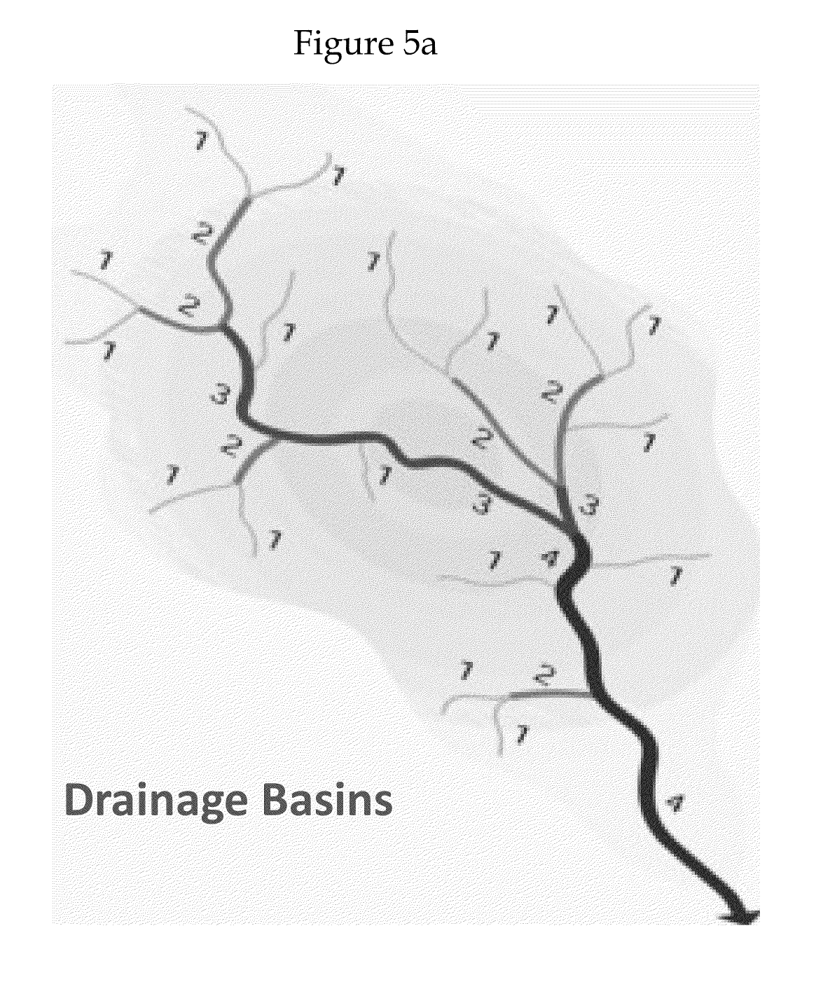

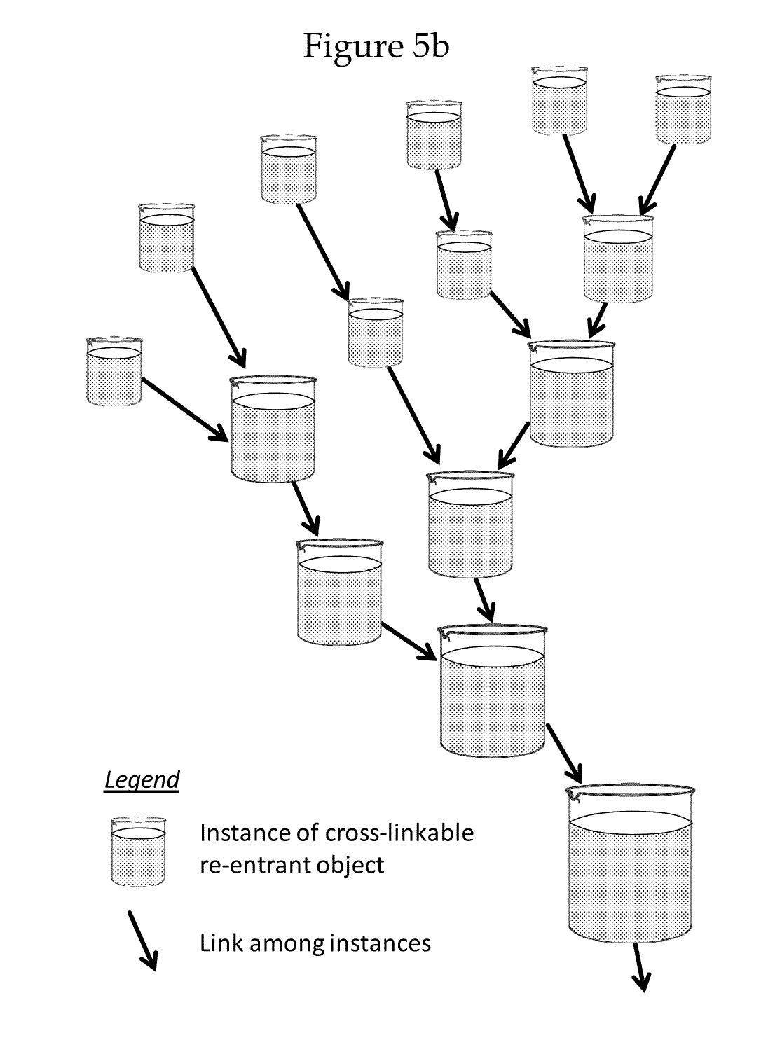

FIGS. 5a illustrates water drainage in a basin and FIG. 5b illustrates a configuration of cross-linked instances in a dendritic configuration that models the water drainage. FIG. 5a is merely one example of a water drainage system in which smaller streams coalesce to form larger streams. FIG. 5b shows how instances may be configured to create a reactive transport model of the drainage system. Each instance may represent an interval along a stream and the links represent the flow of water.

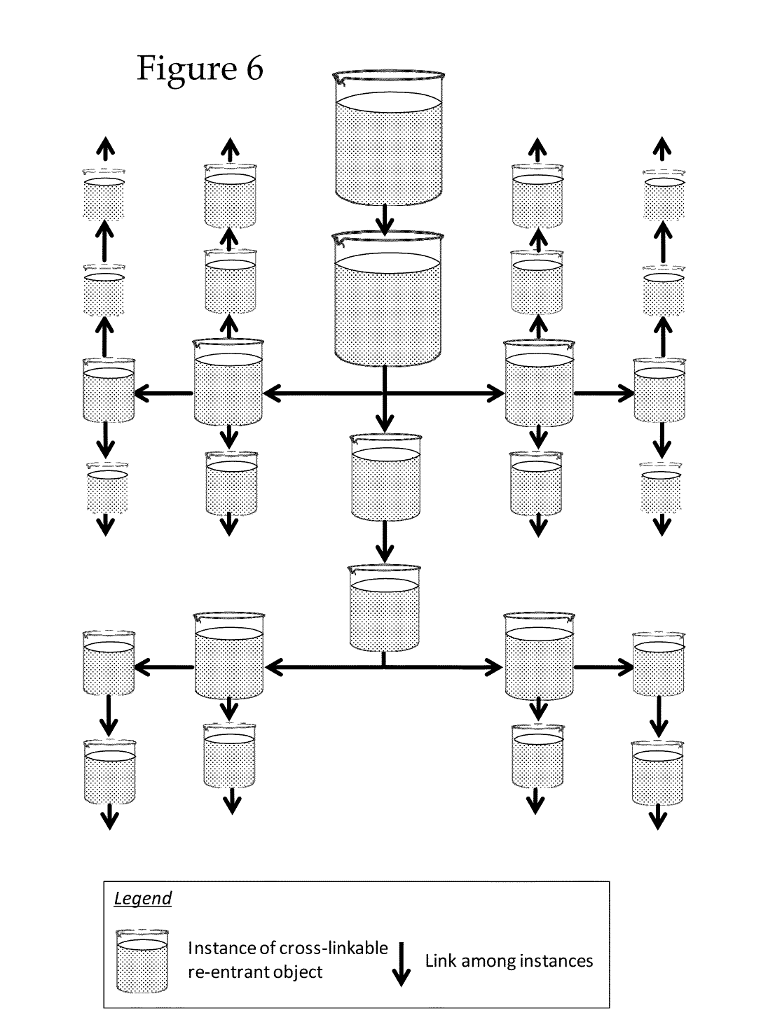

FIG. 6 illustrates a configuration of cross-linked instances that models a fluid distribution network. Each instance may represent a length of pipe in the network and the links represent flow along the pipes.

The configurations illustrated in FIGS. 3-6 are merely exemplary. Different configurations may be modeled. Further, the division of instances for configurations may be varied including which instances are shown in FIGS. 3-6.

Referring back to FIG. 1, the flow of mobile phases, chemical species, or heat across a link may have a known direction. In block 106, the direction of the flow across that link may be specified as a state of transport rate and direction for the instances connected by that link. The flow of mobile phases, chemical species, or heat across a link may have a variable direction, in which case the state of transport rate and direction may be specified at each pass through the time marching loop, as described below with respect to blocks 106-116. In block 106, the rates and directions of the flow of mass and heat energy across the links among instances are set. If the flow of mass and heat is invariant, the state of transport may need to be evaluated only once, upon the first pass through the time marching loop.

The time marching loop may include the loop of blocks 106-116. The program may follow the time marching loop that begins at the simulation starting point and incrementally moves toward the end-point in discrete time steps of length Δt. The time marching loop illustrated in FIG. 1 is merely exemplary and may include more or fewer steps, and those steps may be ordered differently. In one embodiment, the rates and directions of transport may in some cases be known and prescribed at the time of cross-linking and remain invariant over the simulation. In an alternative embodiment, the rates and directions of transport may change over the course of the simulation, in which case they are re specified at the onset of each individual time step in block 106. Accordingly, block 106 may or may not be part of the time marching loop but may specify the rates and directions of the flow of mass and heat energy across the links among instances.

Once the rates and directions of transport are specified, the program may query each instance for the size of the time step that may be stepped over without risking instability, as shown in block 108. The minimum time step for each instance may be determined according to the criteria imposed by a combination of von Neumann's criterion and Courant's criterion, or through other transport equations. The program may use the minimum such value reported among the instances to set the time step length Δt in block 108, and the program may step forward in time by this Δt amount. To complete the time step, the program may first call a member function of each instance to cause the instance to evaluate the rates of mass and heat transport across its links. Querying instances for the time step length may be done to maintain numerical stability, and the least of the time step lengths reported by the plurality of instances may be the selected time step length Δt in block 108. Then in block 110, the program steps forward in time by the time step length Δt.

After advancing of the time step, the transport equations are calculated in block 112. In particular, for each instance there may be a computation of the net transport of mass and heat energy into or out of the instance over the course of the time step. The instance adjusts its bulk composition and temperature from the rates determined and the length of the time step.

Mass and heat energy are transported in the presence of a mobile phase by a number of processes which may include advection of the mobile phase, molecular diffusion, heat conduction, hydrodynamic dispersion, and turbulent mixing. To evaluate the flow of mobile phases, chemical species, or heat across a link, an instance may solve an equation mathematically describing the transport process. The equations describing the transport processes may fall into two classes: zero-order and first-order. A zero-order equation is written in terms of the concentration of a chemical component, or of temperature, whereas a first-order equation contains the first spatial derivative of concentration or of temperature. Although transport of a chemical component may in large part be due to flow of the mobile phase (the zero-order effects), it may also occur due to diffusion, dispersion, and turbulent mixing (first-order effects). The direction of transport due to first-order effects may be either along or counter to the direction in which the mobile phase is flowing. The advection of dissolved mass across a link between one instance and another instance is described by the zero-order equation:

Jₒ=QCᵤₚ (Equation 1)

where Jₒ is the rate at which a chemical component is transported into the instance (or out if it, if Jₒis negative), in moles per second. Q is the rate in cubic meters per second at which the mobile phase moves from the linked instance into the instance in question (or vice-versa, if Q is negative). Cᵤₚ is the component's concentration in moles per cubic meter in the instance at the upstream side of the link.

Advection of heat energy may also be zero-order, being given by the equation:

J_{T,o}=QC_{P}Tᵤₚ (Equation 2)

where J_{T,o} is the energy flux in joules per second. Q is the rate in cubic meters per second at which the mobile phase moves from the linked instance into the instance in question (or vice-versa, if Q is negative). C_{P} is the volumetric heat capacity of the mobile phase, in joules per cubic meter per degree. Tᵤₚ is the temperature of the mobile phase in the upstream instance, in degrees.

The molecular diffusion, hydrodynamic dispersion, and turbulent mixing of a chemical component from one instance to another, in contrast, may be described by a first-order equation. The mass flux arising from these processes may be computed according to the equation:

J₁=τ(Cₗᵢₙₖ−C) (Equation 3)

where J₁ is the mass flux by first-order processes into the instance in question (or out of it, for negative values), in moles per second. τ is the transmissivity between the instance in question and the linked instance, in cubic meters per second. Cₗᵢₙₖ and C are the component's concentration at the linked instance and the instance in question, respectively, in moles per cubic meter. The transmissivity τ may be determined from relevant quantities such as the diffusion coefficient, dispersion length, and mixing length, as well as geometric considerations. Geometric considerations may include the spacing between the instances and cross sectional area of the link.

The transfer of heat energy is similarly computed according to:

J_{T,1}=τ_{T}(Tₗᵢₙₖ−T) (Equation 4)

where J_{T,1} is the flux of heat into and out of the instance in question due to first-order processes, most notably heat conduction, in joules per second. τ_{T} is the thermal transmissivity in joules per degree per second. Tₗᵢₙₖ and T are the temperatures of the linked instance and the instance in question, in degrees.

To allow each instance to evaluate the transport of component mass and heat energy according to the equations above, the program may pass to the instances values for: 1) the flow rate Q across each link; and 2) as the transmissivities τ and/or τ_{T}. In cases in which flow in the domain being modeled is steady, the values may be passed only once, before entering the time marching loop (i.e. the time marching loop from block 116 may go to block 108 rather than block 106 in FIG. 1). When the flow varies in time, values for the flow rate and transmissivities may be passed repeatedly within the time marching loop, upon commencing each time step (i.e. the time marching loop passes through block 106 in FIG. 1 in order to set the values for each loop).

Referring back to FIG. 1, in block 114, the program calls a member function that causes the instance to evaluate the chemical equations in light of changing composition and temperature, as well as the passage of time. In other words, the instances evaluate the progress of chemical reactions and the change in chemical state in response to the transport of mass and heat energy during the passage of time. Once the transport equations have been evaluated in block 112, the instance may re-evaluate its chemical state in block 114 to account for changing composition and temperature and the passage of time. It may solve an equation that describes reaction in multi-component systems. Such equations may include, but are not limited to: 1) a mass balance equation for each chemical component, by adding the amount of the component taken up in composing the various species and phases in the instance's chemical system; 2) a mass action equation for each reaction held in equilibrium; the equation prescribes that the activities of the species in the reaction agree with the reaction's equilibrium constant; 3) activity coefficient equations describing the thermodynamic non-ideality in the system; and/or 4) kinetic rate equations describing the time rates at which the reactions that are not held in equilibrium proceed. The history of the multi-component reaction problem, a complete mathematical formulation of it, and precise techniques for computing solutions to it are discussed in C. M. Bethke, “Geochemical and Biogeochemical Reaction Modeling,” Cambridge University Press, 543 pages, 2008, which is hereby incorporated by reference.

Referring back to FIG. 1, and upon completing block 114, the program continues to advance the time marching loop in block 116 by taking further time steps. The program continues to march forward in time until the end-point t_{end} of the simulation is reached.

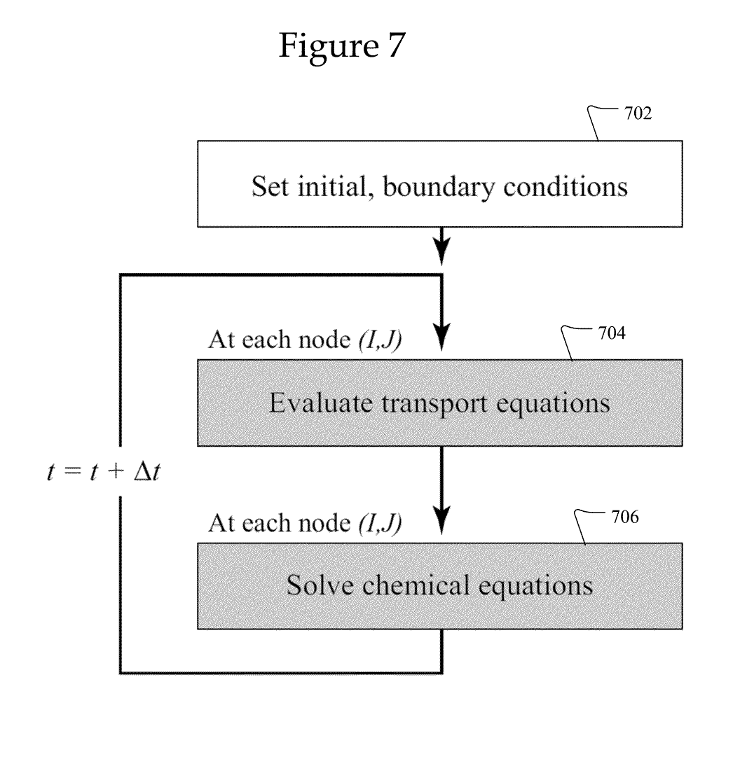

FIG. 7 is a flow chart of parallel computing of reactive transport. The modeling described herein may be performed with parallel computing processes. Instances of a re-entrant software routine which include member functions that: 1) evaluate the multicomponent transport of chemical mass and the transfer of heat energy; and 2) trace the progress of chemical reactions, might therefore be assembled to form a reactive transport model. The resulting reactive transport model may further be adapted to execute on parallel computers, so that the evaluation of transport and the evaluation of chemical reaction progress are performed in parallel, since the software object has an encapsulated memory space. According to embodiments described with respect to FIG. 1, the method for tracing a reactive transport simulation with the cross-linkable re-entrant software routine may include a time marching loop, within which several computing procedures may be accomplished for each instance of the routine. The time marching loop may include the bulk of the computing effort required to complete the simulation.

In FIG. 7, the initial and boundary conditions are set in block 702 which may be similar to block 102 of FIG. 1. Then for each node (i.e. instance), the transport equations may be evaluated in block 704 and the chemical equations may be solved in block 706 as part of the time marching loop. In one embodiment, the transport equations and chemical equations may be part of work-sharing loops and may be evaluated/solved by running as parallel processes (e.g. with parallel processors). Because the cross-linkable software routine is re-entrant (i.e. contains its own encapsulated memory space), and since it includes its own functionality, the instances of the software routine may be operated in parallel on multiprocessor computers, and the evaluation of transport equations and the evaluation of chemical equations may be performed in parallel to speed up completion of the modeling calculations. At the start of the time marching loop in FIG. 1, for example, each instance may report a limiting time step. Similarly, each instance may compute the rate at which mass and heat energy move across the links to other instances, and each instance may evaluate the equations describing a chemical reaction, where these evaluations may be performed in parallel by multiple processors.

To assemble the instances into a parallel code, three work sharing loops across the instances may be set up at each step in the time marching procedure. The work-sharing loops may include: 1) causing each instance to compute a limiting time step; 2) causing each instance to compute the transport of chemical mass and heat energy into and away from other instances; and 3) causing each instance to evaluate the equations describing the chemical reactions considered. A user may create the work-sharing loops using an application programmer interface designed for parallel programming. Such application programmer interfaces may include but are not limited to OpenMP and/or Message Passing Interface. Each pass through the work sharing loop may be assigned by the computer's scheduler to be completed on an arbitrary processor. In this way, the computing operations involving a number of instances may be performed simultaneously.

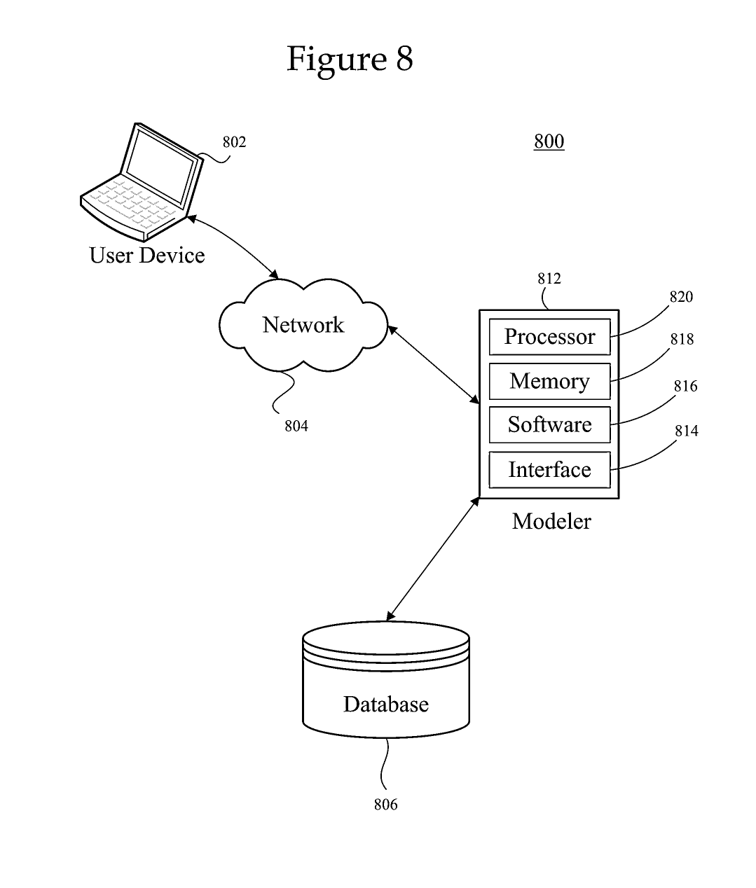

FIG. 8 is a computer network architecture 800. In particular, FIG. 8 illustrates an exemplary computing/network environment 800 for running the modeling and simulation described above. The network connection 804 may be optional or may be used for the input/output of data or for the work sharing of processes (i.e. parallel processes are assigned over the network or to processors across the network). The modeler 812 may be any computing device for performing the modeling and simulation described above.

In the network system 800, a user device 802 is coupled through a network 804 with a modeler 812 and/or a database 806. Herein, the phrase “coupled with” is defined to mean directly connected to or indirectly connected through one or more intermediate components. Such intermediate components may include both hardware and software based components. Variations in the arrangement and type of the components may be made without departing from the spirit or scope of the claims as set forth herein. Additional, different or fewer components may be provided. Accordingly, the modeler 812 may be coupled directly or through a network (e.g. the network 804) with the database 806. In alternative embodiments, the modeler 812 may be a part of the database 806. Likewise, the modeler 812 may be part of the user device 802.

The user device 802 may be a computing device which allows a user to connect to a network 804, such as the Internet. The user device 802 may provide an interface for modifying/accessing/controlling the modeler 806, including modifying instances (e.g. setting the initial states). The user device 802 may also be referred to as a client device and may include a computing device capable of sending or receiving signals, such as via a wired or a wireless network (e.g. the network 804, which may be the Internet). The user device 802 may, for example, include a desktop computer or a portable device, such as a cellular telephone, a smart phone, a display pager, a radio frequency (RF) device, an infrared (IR) device, a Personal Digital Assistant (PDA), a handheld computer, a tablet computer, a laptop computer, a set top box, a wearable computer, an integrated device combining various features, such as features of the forgoing devices, or the like. The user device 802 may include or may execute a variety of operating systems, including a personal computer operating system, such as a Windows, iOS or Linux, or a mobile operating system, such as iOS, Android, or Windows Mobile, or the like. The user device 802 may include or may execute a variety of possible applications, such as database management programs that may manage the database 806 with or without the modeler 812. In one embodiment, the user device 802 is configured to request and receive information from a network (e.g. the network 804, which may be the Internet).

The database 806 may be coupled with the modeler 812 and/or the user device 802 or other devices. The database 806 may be optional in the system 800. In one embodiment, the database 806 may be used to store input or output data, or store the instances and model that are generated by the modeler 812. Alternatively, the modeler 812 may use local memory or storage for the data that is stored at the database 806. The database 806 may be any device that stores data, such as a memory. For example, a computing device with a memory may be a database that stores data.

The modeler 812 may perform any of the steps or processes discussed above, including the creation and operation of a model. In one embodiment, the modeler 812 may be part of the database 806 or may be part of the user device 802. The modeler 812 may include or access parallel computing functionality (e.g. with multiple processors or a single processor running multiple processes) for performing the functions described with respect to FIG. 7. The modeler 812 may include a processor 820, memory 818, software 816 and an interface 814. The interface 814 may communicate with the user device 802 and/or the database 806. The interface 814 may include a user interface configured to allow a user and/or administrator to interact with any of the components of the modeler 812, such as setting initial values/states or modifying the instances for the model. The processor 820 in the modeler 812 may include a central processing unit (CPU), a graphics processing unit (GPU), a digital signal processor (DSP) or other type of processing device. The processor 820 may be a component in any one of a variety of systems. For example, the processor 820 may be part of a standard personal computer or a workstation. The processor 820 may be one or more general processors, digital signal processors, application specific integrated circuits, field programmable gate arrays, servers, networks, digital circuits, analog circuits, combinations thereof, or other now known or later developed devices for analyzing and processing data. The processor 820 may operate in conjunction with a software program, such as code generated manually (i.e., programmed).

The processor 820 may be coupled with a memory 818, or the memory 818 may be a separate component. The interface 814 and/or the software 816 may be stored in the memory 818. The memory 818 may include, but is not limited to, computer readable storage media such as various types of volatile and non-volatile storage media, including random access memory, read-only memory, programmable read-only memory, electrically programmable read-only memory, electrically erasable read-only memory, flash memory, magnetic tape or disk, optical media and the like. The memory 818 may include a random access memory for the processor 820. Alternatively, the memory 818 may be separate from the processor 820, such as a cache memory of a processor, the system memory, or other memory. The memory 818 may be an external storage device or database for storing recorded ad or user data. Examples include a hard drive, compact disc (“CD”), digital video disc (“DVD”), memory card, memory stick, floppy disc, universal serial bus (“USB”) memory device, or any other device operative to store ad or user data. The memory 818 is operable to store instructions executable by the processor 820. In one embodiment, the memory 818 may be the database 806 although FIG. 8 illustrates the database 806 as a separate entity in another embodiment.

The functions, acts or tasks illustrated in the figures or described herein may be performed by the programmed processor executing the instructions stored in the memory 818. The functions, acts or tasks are independent of the particular type of instruction set, storage media, processor or processing strategy and may be performed by software, hardware, integrated circuits, firm-ware, micro-code and the like, operating alone or in combination. Likewise, processing strategies may include multiprocessing, multitasking, parallel processing and the like. The processor 820 is configured to execute the software 816. The software 816 may include instructions for the modeling process described with respect to FIG. 1.

The interface 814 may be a user input device for accessing/managing the database 806. The interface 814 may include a keyboard, keypad or a cursor control device, such as a mouse, or a joystick, touch screen display, remote control or any other device operative to interact with the modeler 812. The interface 814 may include a display coupled with the processor 820 and configured to display an output from the processor 820. The display may be a liquid crystal display (LCD), an organic light emitting diode (OLED), a flat panel display, a solid state display, a cathode ray tube (CRT), a projector, a printer or other now known or later developed display device for outputting determined information. The display may act as an interface for the user to see the functioning of the processor 820, or as an interface with the software 816 for the database 806. In other words, the interface 814 may allow a user or operator to modify the model.

The present disclosure contemplates a computer-readable medium that includes instructions or receives and executes instructions responsive to a propagated signal, so that a device connected to a network can communicate voice, video, audio, images or any other data over a network. The interface 814 may be used to provide the instructions over the network via a communication port. The communication port may be created in software or may be a physical connection in hardware. The communication port may be configured to connect with a network, external media, display, or any other components in system 800, or combinations thereof. The connection with the network may be a physical connection, such as a wired Ethernet connection or may be established wirelessly as discussed below. Likewise, the connections with other components of the system 800 may be physical connections or may be established wirelessly. Any of the components in the network system 800 may be coupled with one another through a network, including but not limited to the network 804. For example, the modeler 812 may be coupled with the database 806 and/or the user device 802 through a network. Accordingly, any of the components in the network system 800 may include communication ports configured to connect with a network, such as the network 804. The network (e.g. the network 804) may couple devices so that communications may be exchanged, such as between a server and a client device or other types of devices, including between wireless devices coupled via a wireless network, for example.

The illustrations of the embodiments described herein are intended to provide a general understanding of the structure of the various embodiments. The illustrations are not intended to serve as a complete description of all of the elements and features of apparatus and systems that utilize the structures or methods described herein. Many other embodiments may be apparent to those of skill in the art upon reviewing the disclosure. Other embodiments may be utilized and derived from the disclosure, such that structural and logical substitutions and changes may be made without departing from the scope of the disclosure. Additionally, the illustrations are merely representational and may not be drawn to scale. Certain proportions within the illustrations may be exaggerated, while other proportions may be minimized. Accordingly, the disclosure and the figures are to be regarded as illustrative rather than restrictive.

We claim:

1. A method of constructing a numerical model of reactive transport, comprising:
defining a domain as a plurality of reactor mediums, wherein each one of the plurality of reactor mediums has a flow relationship with at least one other one of the plurality of reactor mediums;
establishing, with at least one processor, a re-entrant software routine for each one of the plurality of reactor mediums; and
creating a link that corresponds to each flow relationship between the plurality of reactor mediums, wherein the link is created for each flow relationship between an instance of the re-entrant software routine for a first reactor medium and an instance of the re-entrant software routine for a second reactor medium.

2. The method of claim 1, wherein the links between the instances of the software routine form at least one of a one-dimensional configuration, a branching configuration, a networked configuration, a two-dimensional configuration, or a three-dimensional configuration.

3. The method of claim 1, wherein a flow relationship is movement of a mobile phase or heat energy between the first reactor medium and the second reactor medium.

4. The method of claim 1, further comprising:
defining a state for each instance of the software routine, wherein the state comprises at least one of a concentration of a chemical species, a thermal energy of a reactor medium, a heat capacity of a mobile phase, or a temperature of a mobile phase.

5. The method of claim 1, further comprising:
evaluating, for each of the flow relationships, a rate of at least one of a transport of mobile phase, a transport of a chemical species, or a transport of heat, wherein the rate of transport is calculated for each of the links.

6. A computerized method of simulating the progress of chemical reactions, comprising:
launching, with at least one processor, a plurality of instances of a re-entrant software routine, wherein each one of the instances has a link with at least one of the other instances and the link establishes a connection between the re-entrant software routines for each instance;
setting a state for each instance of the re-entrant software routine; and
evaluating a rate of transport across each of the links based on the state of the instances connected by the link.

7. The method of claim 6, wherein the state comprises at least one of a concentration of a chemical species, a thermal energy of a reactor medium, a heat capacity of a mobile phase, or a temperature of a mobile phase.

8. The method of claim 6, wherein the rate of transport comprises at least one of a transport of mobile phase, a transport of a chemical species, or a transport of heat, wherein the rate of transport is calculated for each of the links

9. The method of claim 6, wherein the evaluating a rate of transport is performed by the instance calculating a solution to an equation mathematically describing a transport process.

10. The method of claim 6, further comprising:
setting a time step;
evaluating an updated state for each instance of the re-entrant software routine; and
setting the state of the instance to the updated state.

11. The method of claim 10, wherein evaluating a rate of transport is performed by the instance calculating a solution to an equation mathematically describing a transport process, and wherein setting the time step is performed by the process querying each instance of the re-entrant software routine; the process calculating a time duration such that a solution to the equation mathematically describing a transport process is stable for the time duration, further wherein the process sets the time step to the time duration.

12. The method of claim 11, wherein evaluating an updated state is performed by each instance based on the state, the time step, and the rate of transport across each link connecting the instance to another instance.

13. The method of claim 10, wherein evaluating an updated state is performed by each instance calculating a solution to an equation mathematically describing a reaction in a multi-component system.

14. The method of claim 10, wherein the evaluating a rate of transport and evaluating an updated state are performed in parallel by more than one processor.

15. A method of simulating the progress of chemical reactions, comprising:
launching a plurality of instances of a re-entrant software routine in a process running on a computer, wherein each one of the instances has a link with at least one other instance;
setting a state for each instance of the re-entrant software routine;
executing, on the computer, a set of instructions that iterates over time, a set of instructions comprising:
evaluating a rate of transport for each link, wherein the evaluating is by the instance of the re-entrant software routine connected by the link with the other instance connected by the link, wherein the evaluating is based on the state of the instance and the state of the other instance; and
evaluating an updated state for each instance of the re-entrant software routine; and
setting the state of the instance to the updated state.

16. The method of claim 15, wherein evaluating a rate of transport is performed by the instance calculating a solution to an equation mathematically describing a transport process.

17. The method of claim 16, wherein the set of instructions iterates for each cycle of a time loop, wherein the time loop starts at a start time, ends at an end time, and cycles for each increase of a time value incrementing by a time step from the start time to the end time, wherein the time step has a time duration such that a solution to the equation mathematically describing a transport process is stable for the time duration.

18. The method of claim 17, wherein evaluating an updated state is performed by each instance based on the state, based on the time step, and based on the rate of transport across each link connecting instances.

19. The method of claim 15, wherein the computer comprises a plurality of processors, and wherein evaluating a rate of transport and evaluating an updated state are performed in parallel by more than one processor of the plurality of processors.

20. A system for constructing a numerical model of reactive transport, comprising a controller and a memory, wherein:
the controller launches a plurality of instances of a software routine in the memory, wherein instance is associated with one of a plurality of reactor mediums, further wherein each one of the plurality of reactor mediums has a flow relationship with at least one other one of the plurality of reactor mediums; and
the controller, for each flow relationship between the reactor mediums, creates a link in the memory between the instances associated with those reactor mediums.

21. The system of claim 20, wherein each instance of the software routine has an encapsulated memory space within the memory.

22. The system of claim 21, wherein the controller sets a state within the memory space of each instance of the re-entrant software routine; and for each instance of the re- entrant software routine and for each link between the instance and another instance, the controller calls the instance to evaluate a rate of transport across the link based on the state of the instance and the state of the another instance.
